(19) United States
(12) Patent Application Publication
(10) Pub. No.: US 2026/0361716 A1
(43) Pub. Date: Nov. 12, 2026

(54) AUTHENTICATION SESSION EXTENSION

(71) Applicant: HEWLETT PACKARD ENTERPRISE DEVELOPMENT LP, Spring, TX (US)

(72) Inventors: Shanmugaraj Sivasubbu, Bangalore (IN); Balasubramanian Narayanan, Bangalore (IN)

(21) Appl. No.: 19/293,513

(22) Filed: Aug. 7, 2025

(30) Foreign Application Priority Data
May 6, 2025 (IN) 202541043890

(51) Int. Cl. H04L 9/40

(52) U.S. Cl. CPC H04L 63/0876

(57) ABSTRACT

In some examples, an authentication server receives a re-authentication request for a client device. The authentication server determines whether a session extension indicator is set to an active value indicating that authentication session extension is enabled. Based on determining that the session extension indicator is set to the active value indicating that authentication session extension is enabled, the authentication server extends the authentication session for the client device as a response to the re-authentication request.

### BACKGROUND

Before a client device connects to a network, an authentication process may first be performed to ensure that the client device is authorized to use the network. The client device can access the network through a network access device.

### BRIEF DESCRIPTION OF THE DRAWINGS

Some implementations of the present disclosure are described with respect to the following figures.

FIG. 1 is a block diagram of an arrangement including a client device, a network access device, and an authentication server, according to some examples.

FIG. 2 is a flow diagram of a dynamic session extension process according to some examples.

FIG. 3 is a block diagram of a storage medium storing machine-readable instructions according to some examples.

FIG. 4 is a block diagram of an authentication server according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A client device can perform an initial authentication with an authentication server for confirming an identity of the client device or a user of the client device, before the client device is allowed to connect to a network. In response to certain events, the client device that has connected to the network may re-authenticate with the authentication server. Each re-authentication after the initial authentication may include a full authentication procedure, which involves an exchange of authentication messages that consumes network resources and resources of the client device and the authentication server. A large number of full authentication procedures performed by many client devices can burden the network and the authentication server. The extra load placed on the network by full authentication procedures may lead to reduced network performance for data communications. Also, if the authentication server becomes overloaded, the time to complete authentication procedures for client devices can increase, which can lead to slower client device operations.

In accordance with some implementations of the present disclosure, an authentication session extension can be performed instead of a full authentication procedure when a re-authentication is triggered in response to an event. An authentication session between a client device and an authentication server can be associated with a set of session parameters, such as any or some combination of the following: a Medium Access Control (MAC) address of the client device, an Internet Protocol (IP) address of the client device, a credential associated with the client device (e.g., a username and password of a user of the client device, a certificate of the client device, or another credential), a protocol used for communications by the client device, a maximum amount of time that the client device can remain connected to a network, information regarding restrictions on resources or services of the network accessible to the client device, Quality of Service (QoS) parameters relating to the quality of communications for the client device, parameters relating to a virtual local area network (VLAN) that the client device can access, or any other parameter that relates to how the client device communicates. In other examples, alternative or additional session parameters may define an authentication session.

Extending an authentication session refers to reusing the set of session parameters associated with the authentication session to allow the client device continued access to the network. The ability to extend the authentication session avoids having to perform a full authentication procedure each time a re-authentication is triggered. By extending the authentication session instead of performing a full authentication procedure, resource usage (of network resources and resources of the client device and the authentication server) associated with the full authentication procedure can be avoided. Avoiding the exchanges of authentication messages of full authentication procedures between client devices and the authentication server reduces the load on network resources so that the performance of data communications and other operations over the network can be improved. Also, reducing the load of the authentication server means that the authentication server can react to authentication requests more quickly.

A re-authentication may be triggered in response to any or some combination of the following events: an expiration of a timer, such as a timer in a client device, in a network access device, or in the authentication server; movement of the client device between different points of a network or between different networks; a security event that indicates that a re-authentication may be desirable for security purposes; or any other event.

In some examples of the present disclosure, the decision to extend an authentication session instead of performing a full authentication procedure in response to a re-authentication request can be based on various factors, including any or some combination of the following: whether a session extension enable indicator is set to active value indicating that authentication session extension is enabled; how many times the authentication session for the client device has been extended; or a context of the client device. The authentication server may extend the authentication session if the session extension enable indicator is set to the active value, if a count of how many times the authentication session for the client device has been extended does not violate a count threshold, and/or if the context of the client device satisfies a criterion.

In some examples of the present disclosure, the decision to extend the authentication session at the authentication server is performed without a mutual coordination between the client device and the authentication server regarding extending the authentication session. The extension of the authentication session is transparent to the client device.

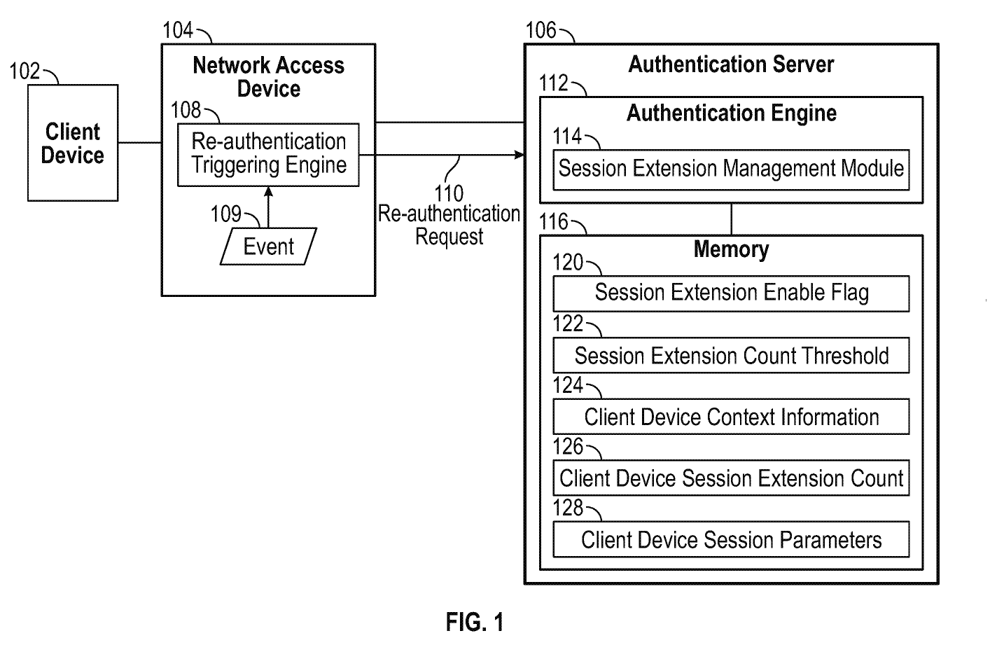

FIG. 1 is a block diagram of an example arrangement that includes a client device 102, a network access device 104, and an authentication server 106. In some examples, the authentication server 106 is separate from the network access device 104. In other examples, the authentication server 106 may be part of the network access device 104. A network access device is a network device that connects a client device to a network. For example, the network access device 104 may include a wireless access point (AP) to which client devices can associate for communicating over a wireless network, such as a wireless local area network (WAN). As another example, the network access device 104 can include a switch or router to which client devices can connect to communicate over a wired network.

The authentication server 106 can authenticate client devices and authorize activities of the client devices. The authentication server 106 may operate according to an Authentication, Authorization, and Accounting (AAA) protocol, such as the Remote Authentication Dial-In User Service (RADIUS) protocol. Another AAA protocol is the Terminal Access Controller Access-Control System Plus (TACACS+) protocol. In further examples, the authentication server 106 may operate according to other authentication protocols, whether standardized, open-source, or proprietary.

Although FIG. 1 shows one client device 102 and one network access device 104, in other examples, multiple client devices can be connected to the network access device 104, and/or multiple network access devices may connect to client devices. Also, in some examples, there may be more than one authentication server.

The network access device 104 includes a re-authentication triggering engine 108, which can send a re-authentication request 110 to the authentication server 106 in response to an event 109 detected by the re-authentication triggering engine 108. The event 109 may be any of the events discussed further above. The re-authentication request 110 is sent over a communication link connecting the network access device 104 and the authentication server 106.

A "re-authentication request" refers to an authentication request for a client device that had previously performed a full authentication procedure with the authentication server 106. An example of an authentication request is a Medium Access Control (MAC) Access Request according to the RADIUS protocol. Another example of an authentication request is a REQUEST message according to the TACACS+ protocol.

The authentication server 106 includes an authentication engine 112 that can process authentication requests, including the re-authentication request 110. In accordance with some examples of the present disclosure, the authentication engine 112 includes a session extension management module 114 that can decide whether to extend an existing authentication session for the client device 102 or to perform a full authentication procedure in response to the re-authentication request 110.

The authentication server 106 includes a memory 116 that stores information used by the session extension management module 114 to determine whether to extend an existing authentication session. The memory 116 can be implemented using one or more memory devices. In some examples, the memory 116 can store the following information elements that can be used by the session extension management module 114: a session extension enable flag 120, a session extension count threshold 122, client device context information 124 for the client device 102, and a client device session extension count 126.

The session extension enable flag 120 can be set to an active value or an inactive value. For example, if the session extension enable flag 120 is implemented as a single bit stored in the memory 116, then the session extension enable flag 120 can be set to a "1" or "0" (active value) to indicate that authentication session extension is enabled. On the other hand, the session extension enable flag 120 can be set to "0" or "1" (inactive value) to indicate that authentication session extension is disabled. In other examples, the session extension enable flag 120 can be implemented using more than one bit stored in the memory 116.

The session extension count threshold 122 is a predefined value specifying the maximum number of times an authentication session for a client device can be extended. The session extension count threshold 122 may be statically set or dynamically adjustable.

The client device session extension count 126 represents how many times the session extension management module 114 has extended the authentication session of the client device 102. The session extension management module 114 can advance (increment or decrement) the client device session extension count 126 each time an authentication session for the client device 102 is extended.

The session extension management module 114 can compare the client device session extension count 126 to the session extension count threshold 122 to determine whether the authentication session for the client device 102 is to be extended or whether a full authentication procedure is to be performed in response to the re-authentication request 110. If the client device session extension count 126 violates the session extension count threshold 122, then a further authentication session extension for the client device 102 would be blocked by the session extension management module 114. If the client device session extension count 126 does not violate the session extension count threshold 122, then the session extension management module 114 can allow the authentication session to be extended, provided other factors are satisfied (discussed further below).

If the client device session extension count 126 is incremented with each authentication session extension, then the client device session extension count 126 "violates" the session extension count threshold 122 if the client device session extension count 126 exceeds the session extension count threshold 122. On the other hand, if the session extension management module 114 is decremented with each authentication session extension, then the client device session extension count 126 "violates" the session extension count threshold 122 if the client device session extension count 126 falls below the session extension count threshold 122.

The client device context information 124 can include various parameters related to the client device 102. For example, the parameters of the client device context information 124 can include a current location of the client device 102 (e.g., a geographic location of the client device 102, which of multiple network access devices the client device 102 is connected to, or other location information), a MAC address of the client device 102, or an IP address of the client device 102. The client device context information 124 is also used by the session extension management module 114 to decide whether authentication session extension is to be performed in response to the re-authentication request 110.

The memory 116 further stores a set of client device session parameters 128 that define an authentication session for the client device 102. Examples of session parameters are provided further above.

In examples where there are multiple client devices, the memory 116 of the authentication server 106 may store multiple respective instances of the following information elements for the client devices: the client device context information 134, the client device session extension count 126, and the set of client device session parameters 128. For example, for a first client device, the memory 116 may store a first instance of the client device context information 134, a first instance of the client device session extension count 126, and a first set of client device session parameters 128. For a second client device, the memory 116 may store a second instance of the client device context information 134, a second instance of the client device session extension count 126, and a second set of client device session parameters 128.

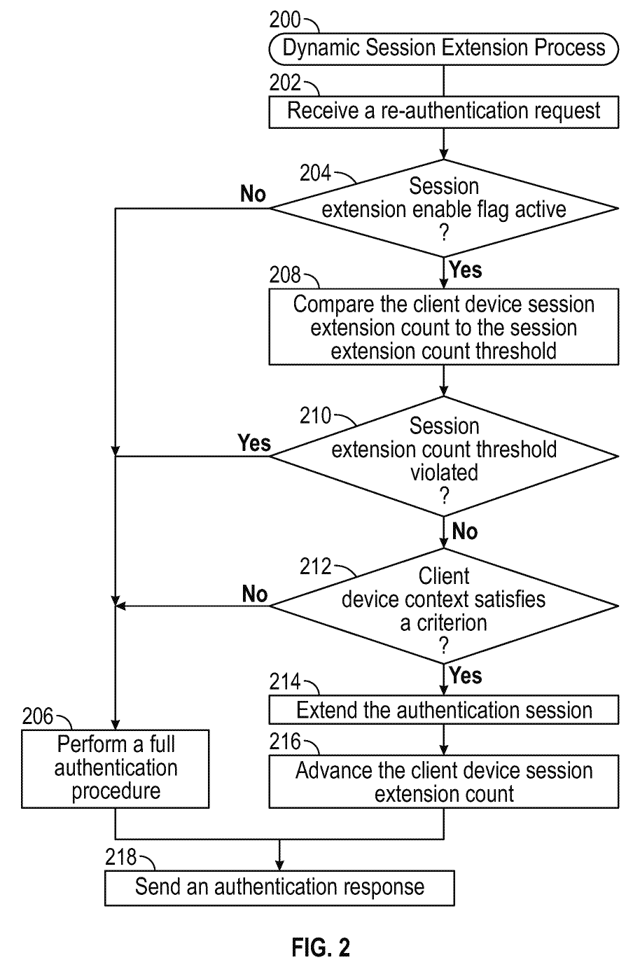

The following refers to FIGS. 1 and 2. FIG. 2 is a flow diagram of a dynamic session extension process 200 that can be performed by the authentication server 106. The authentication server 106 receives (at 202) a re-authentication request, such as the re-authentication request 110.

In response to the re-authentication request, the session extension management module 114 in the authentication server 106 determines (at 204) whether the session extension enable flag 120 is set to the active value. If the session extension enable flag 120 is set to an inactive value, the authentication engine 112 in the authentication server 106 performs (at 206) a full authentication procedure with the client device 102 in response to the re-authentication request.

However, if the session extension enable flag 120 is set to the active value, the session extension management module 114 compares (at 208) the client device session extension count 126 to the session extension count threshold 122. The session extension management module 114 determines (at 210) whether the client device session extension count 126 violates the session extension count threshold 122.

If the client device session extension count 126 violates the session extension count threshold 122, the authentication engine 112 performs (at 206) the full authentication procedure in response to the re-authentication request. However, if the client device session extension count 126 does not violate the session extension count threshold 122, the session extension management module 114 determines (at 212), based on the client device context information 124, whether the client device context satisfies a criterion that permits an extension of the authentication session.

The criterion can include any or some combination of the following. For example, the session extension management module 114 can determine whether a current location of the client device 102 (as indicated by the client device context information 124) satisfies a location criterion (e.g., within a range of permissible locations). The location of the client device 102 may satisfy the location criterion if the client device 102 is located within a specified geographic region (e.g., within a facility of an enterprise or a home). The current location of the client device 102 may violate the location criterion if the client device 102 is located outside the specified geographic region. As another example, the current location of the client device 102 may satisfy the location criterion if the client device 102 is connected to any of a specified collection of network access devices. The current location of the client device 102 may violate the location criterion if the client device 102 is connected to a network access device that is not a member of the specified collection of network access devices.

As a further example, the session extension management module 114 can determine whether a current IP address of the client device 102 (as indicated by the client device context information 124) satisfies an IP address criterion. The current IP address of the client device 102 may indicate a network (or subnet) to which the client device 102 is connected. Authentication session extension is permitted if the client device 102 has an IP address indicating that the client device 102 is connected to a safe or expected network (or subnet). Authentication session extension is not permitted if the client device 102 has an IP address indicating that the client device 102 is not connected to a safe or expected network (or subnet). As a further example, the session extension management module 114 can determine whether the current IP address of the client device 102 is within a range of permissible IP addresses. If so, authentication session extension is permitted; if not, authentication session extension is blocked. An example of a range of permissible IP addresses is a pool of IP addresses that can be assigned client devices by a Dynamic Host Configuration Protocol (DHCP) server.

As another example, the session extension management module 114 can determine whether a current MAC address of the client device 102 (as indicated by the client device context information 124) satisfies a MAC address criterion. In an example, the session extension management module 114 can determine if the current MAC address of the client device matches an initial MAC address of the client device 102. The "initial" MAC address of the client device 102 is the MAC address used when the client device 102 performed the initial authentication procedure with the authentication server 106. If the current MAC address of the client device does not match the initial MAC address, then the authentication session extension is blocked. However, if the current MAC address of the client device matches the initial MAC address, then the authentication session extension is allowed by the session extension management module 114.

If the session extension management module 114 determines (at 212), based on the client device context information 124, that the client device context does not satisfy the criterion that permits the extension of the authentication session, the session extension management module 114 performs (at 206) the full authentication procedure. However, if the client device context permits the authentication session extension, then the session extension management module 114 extends (at 214) the authentication session for the client device 102. Extending the authentication session refers to reusing the set of client device session parameters 128 that define the authentication session for the client device 102.

The session extension management module 114 advances (at 216) the client device session extension count 126 in response to extending the authentication session. Advancing the client device session extension count 126 can refer to incrementing the count 126 or decrementing the count 126.

The authentication engine 112 sends (at 218) an authentication response that is responsive to the re-authentication request. The authentication response can contain different information depending upon whether the full authentication procedure is performed or the authentication session is extended. For example, if the authentication session is extended, the authentication response can contain an indication that the authentication session is extended, so that the network access device 104 does not forward the authentication response to the client device 102 for the purpose of triggering or completing the full authentication procedure. However, if the decision is to perform a full authentication procedure, the authentication engine 112 can send the authentication response to the network access device 104, which forwards the authentication response to the client device 102 to complete the full authentication procedure that includes an exchange of authentication messages between the client device 102 and the authentication server 106.

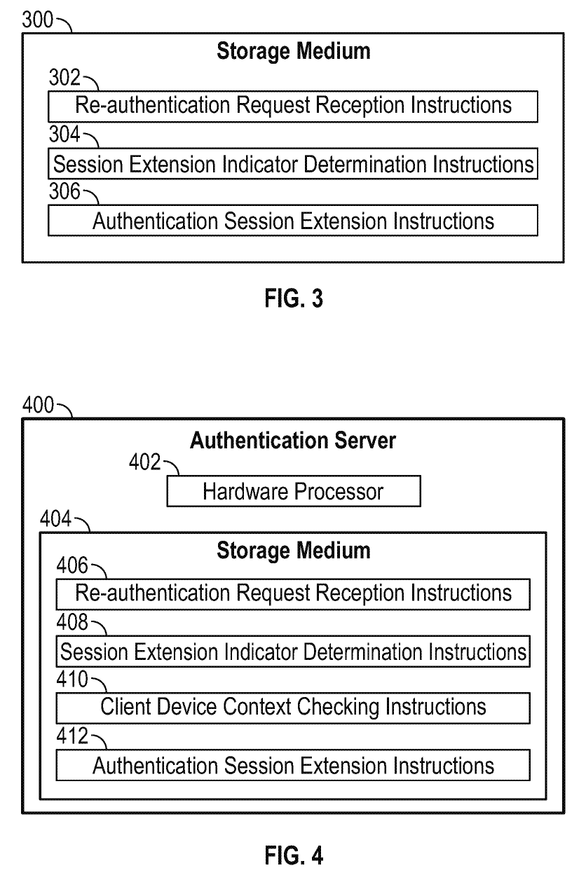

FIG. 3 is a block diagram of a non-transitory machine-readable or computer-readable storage medium 300 storing machine-readable instructions that upon execution cause an authentication server to perform various tasks according to some examples of the present disclosure. An example of the authentication server is the authentication server 106 of FIG. 1.

The machine-readable instructions include re-authentication request reception instructions 302 to receive a re-authentication request for a client device. The re-authentication request may be triggered at a network access device to which the client device is connected. The triggering of the re-authentication request is in response to an event.

The machine-readable instructions include session extension indicator determination instructions 304 to determine whether a session extension indicator is set to an active value indicating that authentication session extension is enabled. An example of the session extension indicator is the session extension enable flag 120 of FIG. 1.

The machine-readable instructions include authentication session extension instructions 306 to, based on determining that the session extension indicator is set to the active value indicating that authentication session extension is enabled, extend the authentication session for the client device as a response to the re-authentication request. If the session extension indicator is set to an inactive value, the authentication server can perform a full authentication procedure in response to the re-authentication request.

In some examples, the extending of the authentication session is performed instead of the full authentication procedure in response to the re-authentication request.

In some examples, based on determining that the session extension indicator is set to the active value, the authentication server can check how many times the authentication session for the client device has been extended. The extending of the authentication session for the client device as the response to the re-authentication request is further based on how many times the authentication session for the client device has been extended.

In some examples, the authentication server can compare a count (e.g., 126 in FIG. 1) of how many times the authentication session for the client device has been extended to a count threshold (e.g., 122 in FIG. 1). The extending of the authentication session for the client device as the response to the re-authentication request is further based on the count not violating the count threshold.

In some examples, based on the count violating the count threshold, the authentication server can perform a full authentication procedure with the client device in response to the re-authentication request.

In some examples, the authentication server can advance (increment or decrement) the count in response to extending the authentication session for the client device as the response to the re-authentication request.

In some examples, the authentication server can send, from the authentication server to the network access device, a re-authentication response containing an indication that the authentication session has been extended.

In some examples, the authentication server can check a context of the client device. The context may be represented by the client device context information 124 of FIG. 1, for example. The extending of the authentication session as the response to the re-authentication request is further based on the context.

In some examples, the context includes a current location of the client device. The authentication server can determine whether the current location of the client device is within a range of permissible locations. The extending of the authentication session as the response to the re-authentication request is further based on the current location of the client device being within the range of permissible locations.

In some examples, the context includes a current MAC address of the client device. The authentication server can determine to extend the authentication session based on the current MAC address of the client device matching an initial MAC address of the client device.

In some examples, the context includes a current IP address of the client device. The authentication server can determine to extend the authentication session based on the current IP address of the client device being within a range of permissible IP addresses.

In some examples, the range of permissible IP addresses includes a pool of IP addresses of a DHCP server.

In some examples, the authentication server can decide to extend the authentication session at the authentication server without a mutual coordination between the client device and the authentication server regarding extending the authentication session.

FIG. 4 is a block diagram of an authentication server 400 according to some examples of the present disclosure. An example of the authentication server 400 is the authentication server 106 of FIG. 1.

The authentication server 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The authentication server 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include re-authentication request reception instructions 406 to receive a re-authentication request for a client device. The re-authentication request is received from a network access device to which the client device is connected.

The machine-readable instructions in the storage medium 404 include session extension indicator determination instructions 408 to determine whether a session extension indicator is set to an active value indicating that authentication session extension is enabled.

The machine-readable instructions in the storage medium 404 include client device context checking instructions 410 to, based on determining that the session extension indicator is set to the active value indicating that authentication session extension is enabled, check whether a context associated with the client device satisfies a criterion. The context can include any or some combination of the following: a count of how many times authentication session extension has been performed for the client device, a current location of the client device, or a network address of the client device. The network address can include a MAC address and/or an IP address.

The machine-readable instructions in the storage medium 404 include authentication session extension instructions 412 to, based on the context associated with the client device satisfying the criterion, extend the authentication session for the client device as a response to the re-authentication request.

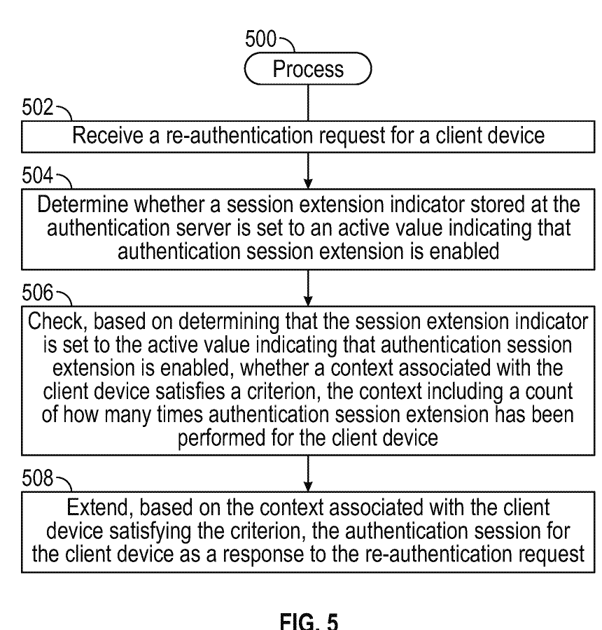

FIG. 5 is a flow diagram of a process 500 according to some examples of the present disclosure. The process 500 may be performed by the authentication server 106 of FIG. 1, for example.

The process 500 includes receiving (at 502) a re-authentication request for a client device. The process 500 includes determining (at 504) whether a session extension indicator stored at the authentication server is set to an active value indicating that authentication session extension is enabled. The session extension indicator may be the session extension enable flag 120 stored in the memory 116 of FIG. 1.

The process 500 includes checking (at 506), based on determining that the session extension indicator is set to the active value indicating that authentication session extension is enabled, whether a context associated with the client device satisfies a criterion, the context including a count of how many times authentication session extension has been performed for the client device. The context may further include other contextual information for the client device, such as one or more of a current location of the client device and a network address of the client device.

The process 500 includes extending (at 508), based on the context associated with the client device satisfying the criterion, the authentication session for the client device as a response to the re-authentication request.

A "memory device" can refer to any or some combination of the following: a dynamic or static random access memory (DRAM or SRAM) device, an erasable and programmable read-only memory (EPROM) device, an electrically erasable and programmable read-only memory (EEPROM) device, or a flash memory device.

An "engine" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an can refer to a combination of one or more hardware processing circuits and machine-readable instructions (software and/or firmware) executable on the one or more hardware processing circuits.

A "module" within an engine (such as the session extension management module 114 within the authentication engine 112 of FIG. 1) can be implemented using a portion of the hardware processing circuitry of the engine, or machine-readable instructions executable by the engine.

FIGS. 2 and 5 are flow diagrams of processes including tasks performed in depicted orders. In other examples, the tasks of any of the processes may be performed in a different order, some of the tasks may be omitted, and other tasks may be added.

A storage medium (e.g., 300 in FIG. 3) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause an authentication server to:
receive a re-authentication request for a client device;
determine whether a session extension indicator is set to an active value indicating that authentication session extension is enabled; and
based on determining that the session extension indicator is set to the active value indicating that authentication session extension is enabled, extend an authentication session for the client device as a response to the re-authentication request.

2. The non-transitory machine-readable storage medium of claim 1, wherein the extending of the authentication session is performed instead of a full authentication procedure in response to the re-authentication request.

3. The non-transitory machine-readable storage medium of claim 1, wherein the instructions upon execution cause the authentication server to:
based on determining that the session extension indicator is set to an inactive value indicating that authentication session extension is disabled, perform a full authentication procedure with the client device in response to the re-authentication request.

4. The non-transitory machine-readable storage medium of claim 1, wherein the instructions upon execution cause the authentication server to:
based on determining that the session extension indicator is set to the active value, check how many times the authentication session for the client device has been extended,
wherein the extending of the authentication session for the client device as the response to the re-authentication request is further based on how many times the authentication session for the client device has been extended.

5. The non-transitory machine-readable storage medium of claim 4, wherein the instructions upon execution cause the authentication server to:
compare a count of how many times the authentication session for the client device has been extended to a count threshold,
wherein the extending of the authentication session for the client device as the response to the re-authentication request is further based on the count not violating the count threshold.

6. The non-transitory machine-readable storage medium of claim 5, wherein the instructions upon execution cause the authentication server to:
based on the count violating the count threshold, perform a full authentication procedure with the client device in response to the re-authentication request.

7. The non-transitory machine-readable storage medium of claim 5, wherein the instructions upon execution cause the authentication server to:
advance the count in response to extending the authentication session for the client device as the response to the re-authentication request.

8. The non-transitory machine-readable storage medium of claim 1, wherein the re-authentication request is received from a network access device to which the client device is connected, and wherein the instructions upon execution cause the authentication server to:
send, from the authentication server to the network access device, a re-authentication response containing an indication that the authentication session has been extended.

9. The non-transitory machine-readable storage medium of claim 1, wherein the instructions upon execution cause the authentication server to:
check a context of the client device,
wherein the extending of the authentication session as the response to the re-authentication request is further based on the context.

10. The non-transitory machine-readable storage medium of claim 9, wherein the context comprises a current location of the client device, and wherein the instructions upon execution cause the authentication server to:
determine whether the current location of the client device is within a range of permissible locations,
wherein the extending of the authentication session as the response to the re-authentication request is further based on the current location of the client device being within the range of permissible locations.

11. The non-transitory machine-readable storage medium of claim 9, wherein the context comprises a current Medium Access Control (MAC) address of the client device, and wherein the instructions upon execution cause the authentication server to:
determine to extend the authentication session based on the current MAC address of the client device matching an initial MAC address of the client device.

12. The non-transitory machine-readable storage medium of claim 9, wherein the context comprises a current Internet Protocol (IP) address of the client device, and wherein the instructions upon execution cause the authentication server to:
determine to extend the authentication session based on the current IP address of the client device being within a range of permissible IP addresses.

13. The non-transitory machine-readable storage medium of claim 12, wherein the range of permissible IP addresses comprises a pool of IP addresses of a Dynamic Host Configuration Protocol (DHCP) server.

14. The non-transitory machine-readable storage medium of claim 1, wherein the instructions upon execution cause the authentication server to:
decide to extend the authentication session at the authentication server without a mutual coordination between the client device and the authentication server regarding extending the authentication session.

15. An authentication server comprising:
a hardware processor; and
a non-transitory storage medium storing instructions executable on the hardware processor to:
receive a re-authentication request for a client device;
determine whether a session extension indicator is set to an active value indicating that authentication session extension is enabled;
based on determining that the session extension indicator is set to the active value indicating that authentication session extension is enabled, check whether a context associated with the client device satisfies a criterion; and
based on the context associated with the client device satisfying the criterion, extend an authentication session for the client device as a response to the re-authentication request.

16. The authentication server of claim 15, wherein the context comprises a count of how many times authentication session extension has been performed for the client device, and wherein the instructions are executable on the hardware processor to:
compare the count to a count threshold,
wherein the extending of the authentication session for the client device as the response to the re-authentication request is further based on the count not violating the count threshold.

17. The authentication server of claim 15, wherein the context comprises a current location of the client device, and wherein the instructions are executable on the hardware processor to:
determine whether the current location of the client device is within a range of permissible locations,
wherein the extending of the authentication session as the response to the re-authentication request is further based on the current location of the client device being within the range of permissible locations.

18. The authentication server of claim 15, wherein the context comprises a network address of the client device, and wherein the instructions are executable on the hardware processor to:
determine to extend the authentication session based on the network address of the client device matching one or more expected network addresses.

19. A method comprising:
receiving, by an authentication server comprising a hardware processor, a re-authentication request for a client device;
determining, by the authentication server, whether a session extension indicator stored at the authentication server is set to an active value indicating that authentication session extension is enabled;
based on determining that the session extension indicator is set to the active value indicating that authentication session extension is enabled, checking, by the authentication server, whether a context associated with the client device satisfies a criterion, the context comprising a count of how many times authentication session extension has been performed for the client device; and
based on the context associated with the client device satisfying the criterion, extending, by the authentication server, the authentication session for the client device as a response to the re-authentication request.

20. The method of claim 19, wherein the context further comprises one or more of a current location of the client device and a network address of the client device.
